(19) United States
(12) Patent Application Publication
(10) Pub. No.: US 2016/0171444 A1
(43) Pub. Date: Jun. 16, 2016

(54) Smart Open Requisition Card View

(71) Applicants: Julie Mathers, Fulton, CA (US); Sharosh Rajasekher, Bangalore (IN); Dominic Philip Haine, San Francisco, CA (US)

(72) Inventors: Julie Mathers, Fulton, CA (US); Sharosh Rajasekher, Bangalore (IN); Dominic Philip Haine, San Francisco, CA (US)

(21) Appl. No.: 14/567,181

(22) Filed: Dec. 11, 2014

(51) Int. Cl. G06Q 10/10; H04L 29/08

(52) U.S. Cl. CPC G06Q 10/1053; H04L 67/02

(57) ABSTRACT

Techniques are described for generating and presenting open requisition card views that describe the state of an open requisition to fill one or more positions within an organization. Each view can be specific to a member of the hiring team. An open requisition card view can include generic fields (which are the same in all views of an open requisition card) and personalized fields (which are personalized for each view according to the member associated with the view). The generic fields can include a requisition pipeline that provides a summary of the candidates applying for an open requisition. The requisition pipeline can include a plurality of sectors that each correspond to a stage of the hiring process. The visual appearance of a given sector can change depending on the number of candidates that are currently within the corresponding stage.

### BACKGROUND

The hiring process to bring on a new employee into an organization is a lengthy and time consuming process. Multiple employees within the organization together form a hiring team that are involved in various stages of the hiring process. For example, a sourcer sources candidates for an open requisition to an open position within the organization. A screener screens the candidates found by the source as an initial pass to create a short list of candidates. One or more interviewers can interview the candidates within the short list and provide feedback to the hiring manager. The hiring manager can select a candidate to hire and request that a background check be performed on the selected candidate. If the selected candidate passes the background checks, an offer can be made and if accepted, the selected candidate becomes an employee of the organization. As shown, there are many stages in the hiring process and it can become confusing for a member of the hiring team to determine whether there is an outstanding action item. Furthermore, a hiring manager can spend long periods of time checking in on the status of each requisition to determine where how requisition is to being filled. This can be very time consuming and confusing.

### SUMMARY

In one embodiment, a computer-implemented method receives, by a processor, a user request to check on the status of a plurality of open requisitions configured for filling a plurality of positions within an organization. The method then identifies, by the processor, an open requisition that a user profile associated with the user request is involved in, the open requisition being configured to fill an open position within the organization. Lastly, the method generates, by the processor, an open requisition card that provides a summary on a plurality of candidates applying for the open requisition, wherein the open requisition card is personalized for the user profile.

In one example, generating the open requisition card includes generating, by the processor and as part of the open requisition card, a requisition pipeline configured to identify a current stage in a hiring process that each of the plurality of candidates are currently in.

In another example, generating the open requisition card includes determining, by the processor, a current stage that a candidate applying for the open position is in within a hiring process, determining, by the processor, that the current stage contains an action item associated with the user profile, and generating, by the processor and as part of the open requisition card, a to-do section that contains the action item. The method can also include detecting, by the processor, user input representative of selecting the action item and executing, by the processor, a function associated with the selected action, the function being configured to complete the selected action.

In another example, generating the open requisition card can include determining, by the processor, a current stage that a candidate applying for the open position is in within a hiring process, determining, by the processor, that a subsequent stage contains an action item that is associated with the user profile, wherein the subsequent stage is dependent on the completion of the current stage, and generating, by the processor and as part of the open requisition card, a waiting-for section that contains another action item which the completion of the current stage depends on. The method can further include detecting, by the processor, user input representative of selecting the another action item and presenting, by the processor and as part of the open requisition card, an option to generate a reminder to complete the another action item.

In another example, the method can further include maintaining, by the processor, an open web socket with a client device which transmitted the user request, wherein the open web socket is configured to maintain an active connection between the client device and the processor to dynamically transmit updates to the open requisition from the processor to the client device.

In another embodiment, a non-transitory computer readable storage medium stores one or more programs comprising instructions for receiving a user request to check on the status of a plurality of open requisitions configured for filling a plurality of positions within an organization, identifying an open requisition that a user profile associated with the user request is involved in, the open requisition being configured to fill an open position within the organization, and generating an open requisition card that provides a summary on a plurality of candidates applying for the open requisition, wherein the open requisition card is personalized for the user profile.

In another embodiment, a computer implemented system comprises one or more computer processors and a non-transitory computer-readable storage medium. The non-transitory computer-readable storage medium comprises instructions, that when executed, control the one or more computer processors to be configured for receiving a user request to check on the status of a plurality of open requisitions configured for filling a plurality of positions within an organization, identifying an open requisition that a user profile associated with the user request is involved in, the open requisition being configured to fill an open position within the organization, and generating an open requisition card that provides a summary on a plurality of candidates applying for the open requisition, wherein the open requisition card is personalized for the user profile.

The following detailed description and accompanying drawings provide a better understanding of the nature and advantages of the present disclosure.

### BRIEF DESCRIPTION OF THE DRAWINGS

FIG. 1 illustrates a system for generating an open requisition card according to one embodiment;

FIG. 2 illustrates open requisition data that can be stored in an open requisition database according to one embodiment;

FIG. 3 illustrates a visual representation of a requisition pipeline according to one embodiment;

FIG. 4 illustrates an example of applicant data according to one embodiment;

FIG. 5 illustrates an exemplary requisition card generation chart according to one embodiment;

FIG. 6 illustrates a requisition cell according to one embodiment;

FIG. 7 illustrates an example of an open requisition card according to one embodiment;

FIG. 8 illustrates a process for generating an open requisition card according to another embodiment; and

FIG. 9 illustrates an exemplary computer system according to one embodiment.

### DETAILED DESCRIPTION

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples alone or in combination with other features described below, and may further include modifications and equivalents of the features and concepts described herein.

Described herein are techniques for generating an open requisition card. A system (which can be a recruiting tool) can generate an open requisition card that summarizes the status of filling an open position within the organization. The summary can describe the status of a plurality of candidates applying for an open position. In some embodiments, a member of the hiring team can request the status of open requisitions which he or she is involved in. In response to the request, the system can return one or more open requisition cards that the requesting member is involved in. In some embodiments, a requisition card view can be generated that is unique to the requesting member. For example, action items which are to be completed by the requesting member can be presented in the requesting member's requisition card view. As another example, action items of other members in the hiring team can be presented in the requesting member's requisition card. This allows the requesting member to nudge other members within the hiring team to complete their action items, particularly if there are dependencies between the action items of the requesting member and the action items of other members in the hiring team.

The system can be implemented on the client side or server side. For example, the system can be implemented on the client device to update requisition cards as new information is received on the client device. For instance, new information provided by other members in the hiring team can cause the requisition card to be updated. As another example, the system can be implemented on a server that is in communication with a client device. Each member in the hiring team can use a client device to submit information related to the hiring of a candidate to fill the open position. User input received on the client device can be transmitted from the client device to the server. The server can process the detected user input to update the information collected that is related to hiring a person for the open position. Once the information has been updated, the server can transmit the updated information to the client devices, which can be used to update the requisition cards. Once updated, the server can transmit the updated requisition card or the necessary changes to update the existing organizational to the client device. The client device can present the requisition card received to the user.

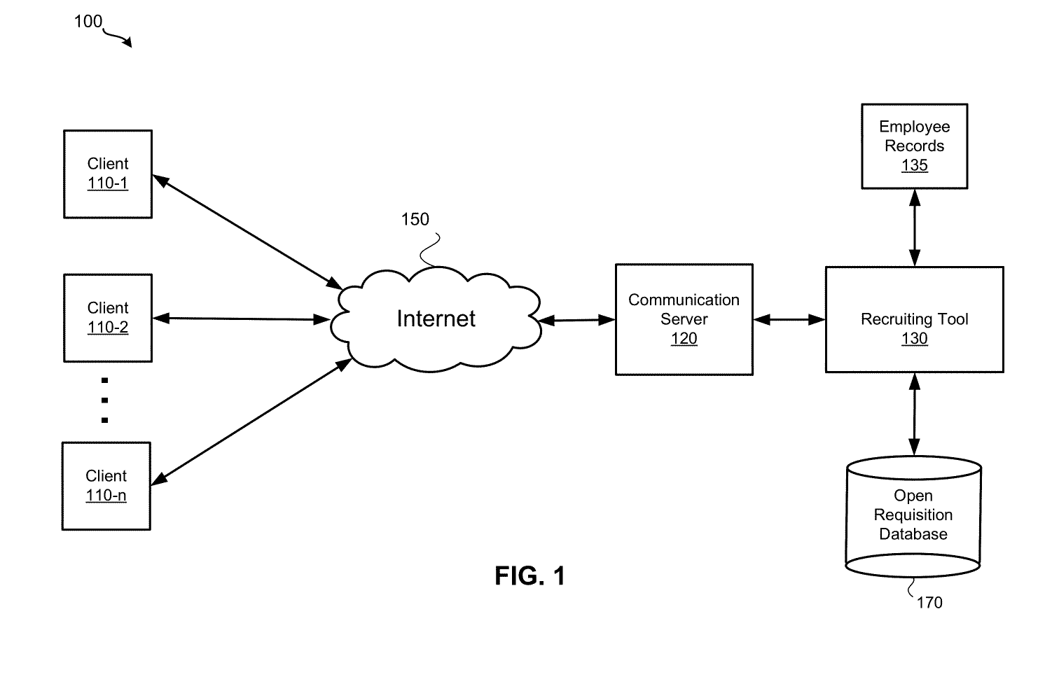

FIG. 1 illustrates a system for generating an open requisition card according to one embodiment. System 100 includes recruiting tool 130. Recruiting tool 130 can be configured to generate open requisition card views. Each open requisition card view can provide a summary on the status of filling an open position within the organization. The open requisition card view can be presented to a user operating a client device. In one example, the server can transmit the open requisition card view to a client device, which in turn presents the open requisition card view on a display on the client device. Alternatively, the client device can process information related to an open position and generate an open requisition card view to be viewed by a client device. In some embodiments, the open requisition card view can be actionable. For example, a member of the hiring team can interact with the open requisition card view to perform one or more actions that are part of the hiring process. For instance, an interviewer can interact with the open requisition card view to submit feedback on an interview. Similarly, a scheduler can interact with the open requisition card view to schedule interviews for the candidate.

In one embodiment, recruiting tool 130 can retrieve candidate data from open requisition database 170. Candidate data can include data that was generated as the candidate goes through the hiring process. For example, candidate data can include the stage of the hiring process that the candidate is currently in (e.g., current stage), data generated by members of the hiring team while the candidate is being reviewed, and personal information that is related to the candidate like the candidates name and contact information. If a candidate is successful in becoming an employee, recruiting tool 130 can update employee records 135.

In one embodiment, recruiting tool 130 can serve as a central hub for members of the hiring team. As each member performs tasks to complete action items that are associated with stages of the hiring process, the results of the performed tasks can be transmitted to recruiting tool 130. Recruiting tool 130 can consolidate the results and notify other members when they have action items. In some examples, the hiring process can include one or more action items that to be performed in each stage. Once all the action items within a stage have been performed, the results can be examined to determine whether the candidate progresses to the next stage. If a candidate is found to be a poor fit for the open position, the candidate can be removed from the hiring process and future action items associated with the candidate do not need to be performed. Alternatively if the candidate progresses to the next stage, recruiting tool 130 can assign action items that are associated with the next stage in the hiring process.

System 100 includes client devices 110-1 to 110-n. Each client device can present a view of the open requisition card to a member in the hiring team that is utilizing the client device. An open requisition card can represents the progress of filling an open requisition. In some examples, recruiting tool 130 can generate a view of the open requisition card (e.g., open requisition card view) that is tailored for a member of the hiring team. The personalized view can contain action items and updates which are specific for the member. As a result, recruiting tool 130 can generate a unique view for each member of the hiring team. While some views may share some of the same action items or updates, each view has been tailored for a specific member. For example, a member can specify the types of action items and the types of updates to present on an open requisition card view.

System 100 further includes communication server 120. Communication server 120 can be configured to communicate with client devices 110-1 to 110-n via internet 150. In some embodiments, communication server 120 can maintain an open socket with a client device. An open socket can allow an active communication channel to exist between communication server 120 and the client device. Advantages of maintaining an active communication channel is that changes to the state of an open requisition can be dynamically transmitted to the client device. This allows the client device to present an up-to-date version of the open requisition card view that takes into account updates submitted by other members in the hiring team, instantly, without having to re-download and re-draw the page. Communication from the client device can be routed through internet 150 to communication server 120, which in turn routes the communication to recruiting tool 130. The communication can include updates on the open requisition. Recruiting tool 130 can process the updates and generate an updated open requisition card view for a member of the hiring team. The updated open requisition card view can be transmitted to communication server 120, which in turn routes it to the client device that corresponds with the member of the hiring team. In some examples, one member of the hiring team can submit an update to the open requisition to recruiting tool 130. The update can be the results of an interview, analysis on the candidate, background check information, to name a few. Upon receiving the update, recruiting tool 130 can process the update to generate an updated open requisition card view for one or more members of the hiring team. The one or more members can also include the member who submitted the update.

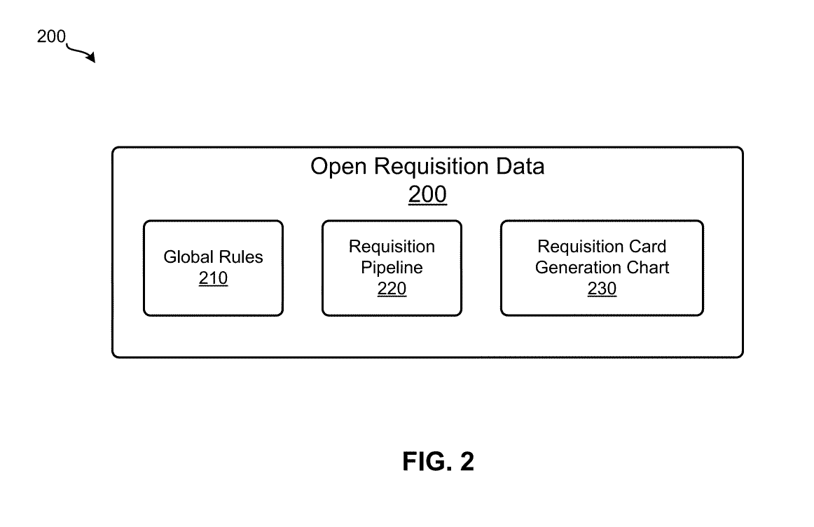

FIG. 2 illustrates open requisition data that can be stored in an open requisition database according to one embodiment. Open requisition data 200 can contain data associated with an open requisition. The data can include rules for generating the open requisition card view and also candidate data. Candidate data can include the candidate's personal information and information generated by members of the hiring team during candidate review.

Open requisition data 200 can include global rules 210. Global rules 210 can include rules which define the visual appearance of the open requisition card view. In one embodiment, global rules 210 can include a global rule that dictates the visual appearance of the open requisition card view based on a severity score associated with the open requisition. Adjustments to the visual appearance can include the color of the open requisition card, the background appearance of the open requisition card, or other visual indicators of the open requisition card. Advantages to adjusting the visual appearance of an open requisition card is that open requisitions that are of higher priority due to a high severity score can take on a different appearance and thus stand out over other open requisition cards. This can draw the member's attention to the open requisition cards that are of high priority. In one example, the severity score of an open requisition can depend on the hiring manager associated with the open position. For instance, an open position belonging to a hiring manager having an senior role within the organization can be assigned a high severity score while another open position belonging to another hiring manager having a junior role within the organization can be assigned a low severity score. This can bring attention to open requisition cards that are associated with upper level management. In another example, the severity score of an open requisition can depend on the urgency of an action item associated with the open position. For instance, an action item can be initially assigned to a member by recruiting tool 130. If the member does not perform tasks to complete the action item, then other members having subsequent action items which depend on the completion of the action item cannot perform their duties. If the member does not complete the action item within a predefined period of time, the severity score can increase thus resulting in a change to the visual appearance of the open requisition card.

In some examples, the severity score can be member dependent. Thus, two open requisition card views for the same open requisition can be assigned different severity scores. The two open requisition card views can belong to two members of the hiring team. For instance, a first member's open requisition card view can be assigned a high severity score when the first member has an outstanding action item. A second member's open requisition card view can be assigned a low severity score when the second member is also waiting for the completion of the outstanding action item so that the second member can perform his action item.

Open requisition data 200 further includes requisition pipeline data 220. Requisition pipeline data 220 provides a summary of the candidates who have applied for the open position. Each candidate can be presented in requisition pipeline 220 based on the candidate's stage in the hiring process. Open requisition data 200 further includes requisition card generation chart 230. Requisition card generation chart 230 can be configured to add details to the open requisition card view for a member in the hiring team. Each member in the hiring team can be associated with a personalized open requisition card view and the personalized details can be specified by requisition card generation chart 230.

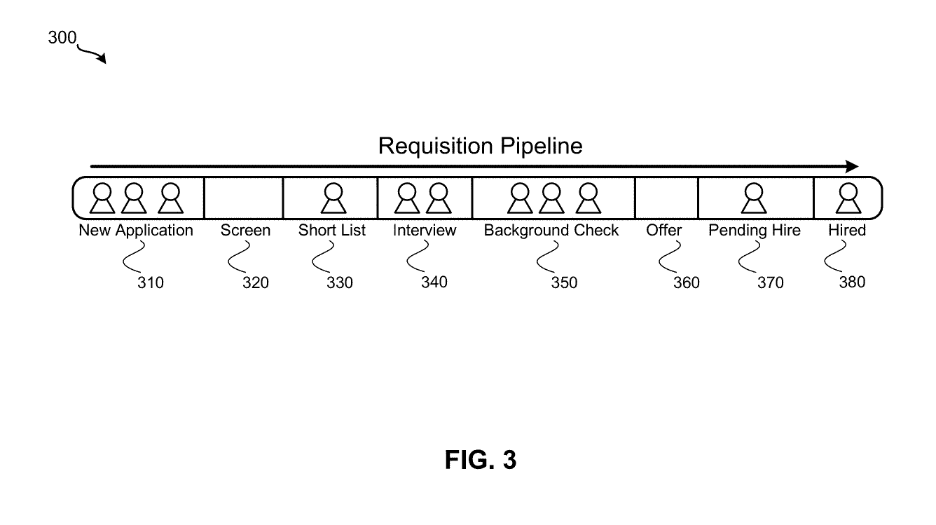

FIG. 3 illustrates a visual representation of a requisition pipeline according to one embodiment. Requisition pipeline 300 can be generated based on requisition pipeline data 220 of FIG. 2. Requisition pipeline 300 can be configured to track the progress of candidates through the various stages that are part of the hiring process for an open requisition. Requisition pipeline 300 can include a plurality of stages and each stage can be configured to identify the candidates that are currently at that stage. Here, new application stage 310 includes three candidates, screen stage 320 has zero candidates, short list stage 330 has one candidate, interview stage 340 has two candidates, background check stage 350 has three candidates, offer stage 360 has zero candidates, pending hire stage 370 has one candidate, and hired stage 380 has one candidate. Each stage can also be configured to store a plurality of requirements that are to be met before the candidate can complete the stage. For example, a requirement to complete interview stage 340 can be to receive interview feedback from the interviewers and for the interview feedback to be above a specified score. As a candidate completes a stage, the candidate can be moved to the next stage in requisition pipeline 300. If a candidate fails a stage, the candidate can be removed from requisition pipeline 300, thus indicating that the candidate is no longer being considered for the open requisition. While one candidate has been hired here, the open requisition being represented by requisition pipeline 300 can include multiple openings and therefore requisition pipeline 300 can be used to track the progress of the other candidates until all openings of the open requisition are filled.

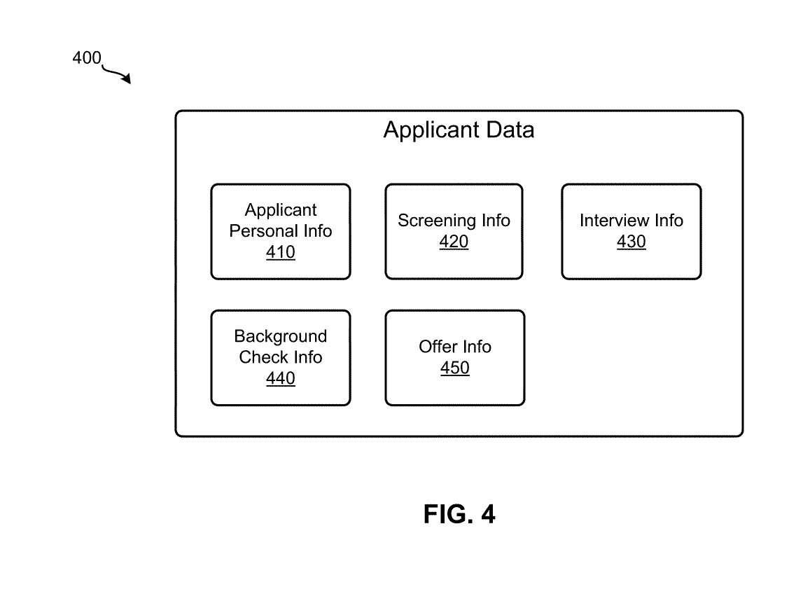

In one embodiment, requisition pipeline 300 can be configured to store a pointer or other identifier associated with candidates applying for the open requisition. The pointer or other identifier can be used to retrieve applicant data on the candidate. FIG. 4 illustrates an example of applicant data according to one embodiment. Applicant data 400 can include application personal information 410. Applicant personal information 410 can include details on the candidate that was not generated based on review by a member of the hiring team. Applicant personal information 410 can include information such as the candidate's name, address, social security number, resume, etc. Applicant data 400 further includes screening information 420. Screening information 420 can include information that was generated by a screener during the screener's review of the candidate. For example, screening information 420 can include notes on the candidate containing the reasons why the candidate passed the screening to join the short list.

Applicant data 400 can also include interview information 430. During the candidate's interviews, one or more interviewers can generate interview feedback based on the interview with the candidate. The interview feedback can be stored in interview information 430. In one example, interview information 430 can include feedback forms that have been populated by the interviewers. In other examples, interview information 430 can store a summary of the interview feedback generated from multiple interviewers.

Applicant data 400 can also include background check information 440. Background check information 440 can include the results of a background check performed on the candidate. Background check information 440 can include credit reports, information from references, and checks on the candidate's work experience. Applicant data 400 can further include offer information 450. Offer information 450 can include details on the offer that was made to the candidate. The details can include the position that the candidate would be in if the candidate were to accept the offer, the job duties of the candidate if the candidate were to accept the offer, and the compensation of the position if the candidate were to accept the offer.

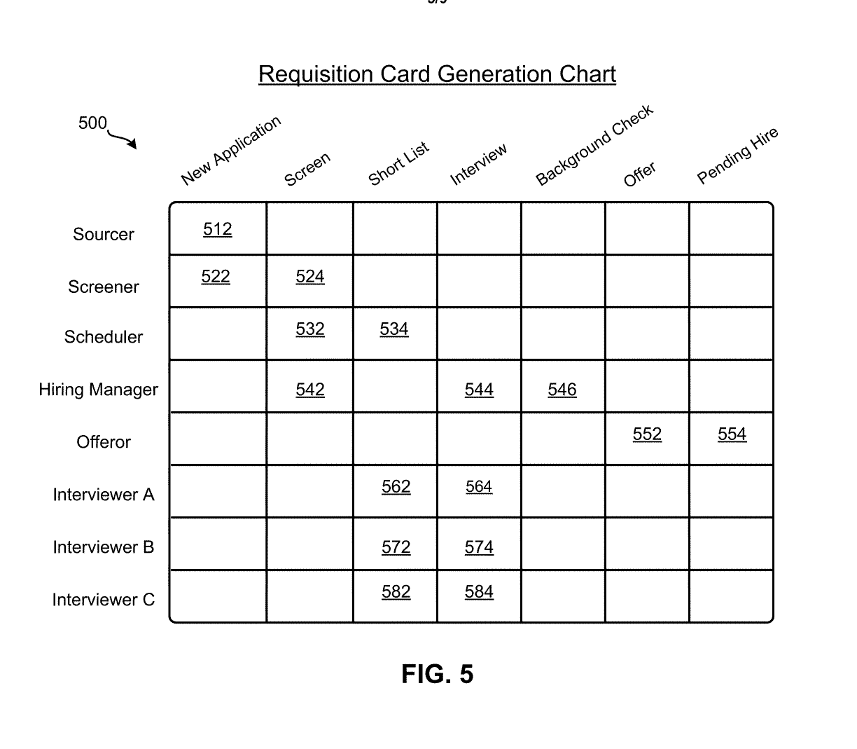

FIG. 5 illustrates an exemplary requisition card generation chart according to one embodiment. Requisition card generation chart 500 is a table that includes a plurality of requisition cells. Each requisition cell can contain instructions for adding content to an open requisition card view. As described above, each open requisition card view can be generated for a particular member of the hiring team and thus be customized for that member. Requisition card generation chart 500 can be configured to provide the customized content. Each requisition cell can contain instructions for generating content for an open requisition card view. Each requisition cell can be associated with a member of the hiring team and a stage of the hiring process. For example, requisition cell 512 is associated with the sourcer and the new application stage of the hiring process. Recruiting tool 130 can process requisition cell 512 when the open requisition card view is being generated for the sourcer and there are candidates that are within the new application stage of the hiring process. Similarly, recruiting tool 130 can process requisition cell 522 and 524 when the open requisition card view is being generated for the screener and there are candidates within the new application stage and the screen stage of the hiring process. As shown, requisition card generation chart 500 includes a list of the members within the hiring team along the y-axis and a list of the stages in the hiring process along the x-axis. Therefore, requisition card generation chart 500 includes a requisition cell for each stage of the hiring process, for each member of the hiring team.

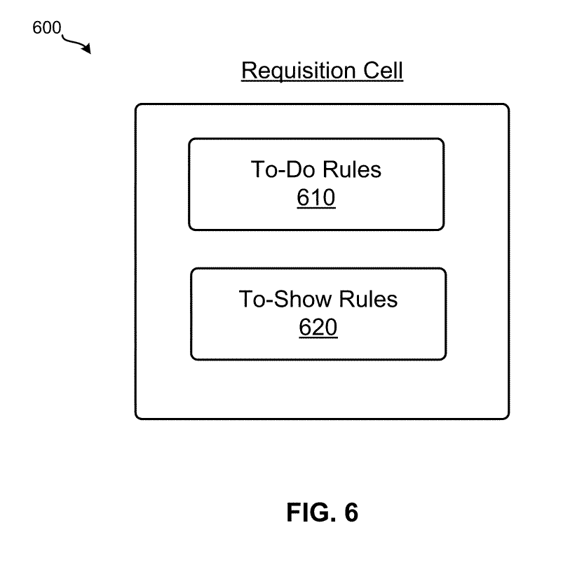

FIG. 6 illustrates a requisition cell according to one embodiment. Requisition cell 600 can include a plurality of rules that define the content that is presented within an open requisition card view. Requisition cell 600 can include to-do rules 610. To-do rules 610 can include rules that define when a notification related to the member's action item is presented within a tile. For example, a rule can define that a notification is to be presented within a “Waiting For You” tile when a member has yet to complete an action item that is assigned to the member. This can allow the member to identify the member's outstanding action items by reviewing the “Waiting For You” tile of the open requisition card view. In one embodiment, the notifications can be actionable. Thus, selecting the notification can cause recruiting tool 130 to transition to an application for completing the action item or alternatively generate a pop-up window for completing the action item.

Requisition cell 600 can further include to-show rules 620. To-show rules 620 can include rules that define when a notification related to another member's action item is presented within a tile. For example, the rule can define that a notification is to be presented within a “Waiting On Others” tile when another member has yet to complete an assigned action item. This allows one member to track the progress of another member's action items. This can useful if the other member's action items affect the completion of the current member's action item. For example, a current member can be assigned an action item to perform a background check. However, the background check action item depends on the interview feedback being received and processed to determine whether the candidate has passed the interviewing stage. A rule within the requisition cell that is associated with interviewing stage can specify that a notification be generated on the open requisition card of the current member when interviewers have not submitted their interview feedback. This allows the current member to keep track of other's action items that are holding back the current member from performing his or her action items (such as a background check). In some embodiments, the notification can be actionable. In one example, user input representative of selecting the notification can generate a list of one or more actions that can be performed. The list of actions can include an action to email the other member to perform the action item, an action to text message the other member to perform the action item, an action to call the other member, an action to report the other member to a manager for not completing the action item, and other types of communication between the current member and others in the organization.

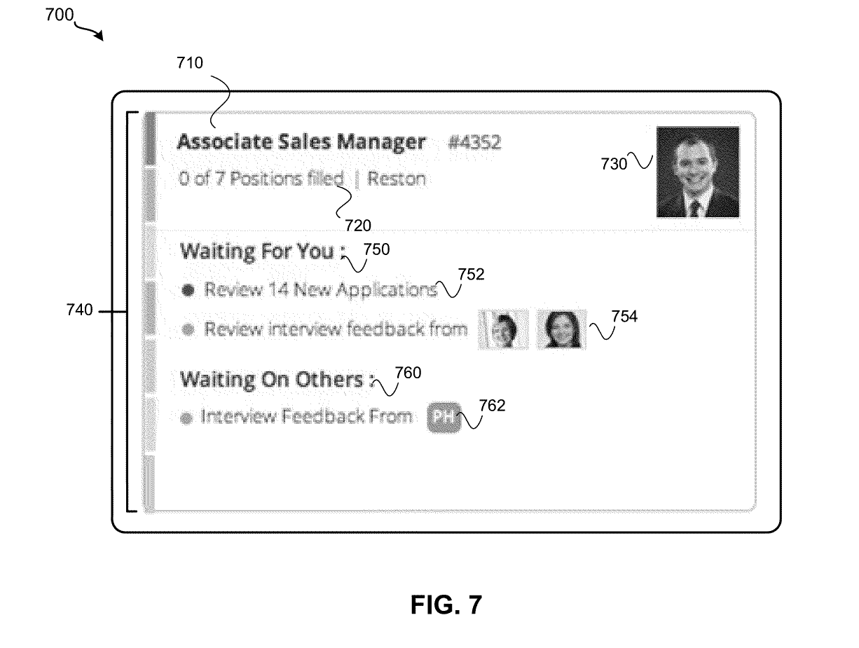

FIG. 7 illustrates an example of an open requisition card according to one embodiment. Open requisition card 700 can be a tile that represents the current state of an open requisition. As described above, open requisition card 700 can be a personalized view that is generated for a particular member in the hiring team. The content presented within open requisition card 700 can be personalized for the particular member. In some embodiments, open requisition card 700 can be presented along with other open requisition cards in an open requisition window that belongs to a member of the hiring team. The open requisition window can contain open requisition cards that are associated with open requisitions which the member is involved in. Open requisitions which the member is involved in and have been filled can optionally be left in the open requisition window or alternatively removed from the open requisition window.

Open requisition card 700 can include fields (or tiles) for presenting information related to the open requisition. The fields (or tiles) can be presented in predefined locations within open requisition card 700. Each field can be configured to present content related to the open requisition. Some of the fields can present generic content while other fields can present personalized content. Generic content can be content which is generically related to the open requisition and thus can be presented in each member's personalized view. Here, job title field 710, status field 720, hiring manager photo field 730, and pipeline field 740 are generic fields while “waiting for you” field 750 and “waiting on others” field 760 are personalized fields.

Job title field 710 can be configured to present the job title of the open requisition. Status field 720 can be configured to present the status of the open requisitions. Here, status field 720 describes that there are seven positions associated with this open requisition and that none of them have been filled. Hiring manager photo field 730 can present an image of a profile picture associated with the hiring manager so that members of the hiring team can easily identify which hiring manager the open requisitions are for. This may allow members to address action items associated with open requisitions for high profile hiring managers ahead of action items associated with open requisitions for low profile hiring managers. Pipeline field 740 can present a visual representation of requisition pipeline 300 in FIG. 3. Requisition pipeline 300 can summarize the stages which the candidates for the open requisition are within the hiring process.

“Waiting for you” field 750 and “waiting on others” field 760 can be personalized tiles which are configured for a member of the hiring team. These personalized tiles can change (thus generating a different open requisition card view) depending on the recipient of the open requisition card. “Waiting for you” field 750 can present one or more notifications of action items which have been assigned to the member. Upon detecting the selection of a notification, the system can initiate a process to complete the corresponding action item. Once the corresponding action item has been completed, the notification can be removed from “waiting for you” field 750. In some embodiments, multiple action items can be presented as a single notification. For example, notification 752 combines 14 action items to review new applications while notification 754 combines two action items to review interview feedback. “Waiting on others” field 760 can present one or more notifications of actions items which have been assigned to other members of the hiring team. In one embodiment, one or more rules stored within the open requisition generation chart can define the notifications that are presented in “waiting on others” field 760. In one example, “waiting on others” field 760 can be configured to present notifications for action items which the member relies upon to complete the member's action items. In another example, “waiting on others” field 760 can be configured to present notifications associated with action items which the member is interested in. For instance, a hiring manager that is interested in the progress of members who directly report to the hiring manager can set up a rule specifying that action items for those members be presented in “waiting for others” field 760. Here, “waiting on others” field 760 includes notification 762 to review feedback and the member who is responsible for the action item (e.g., PH).

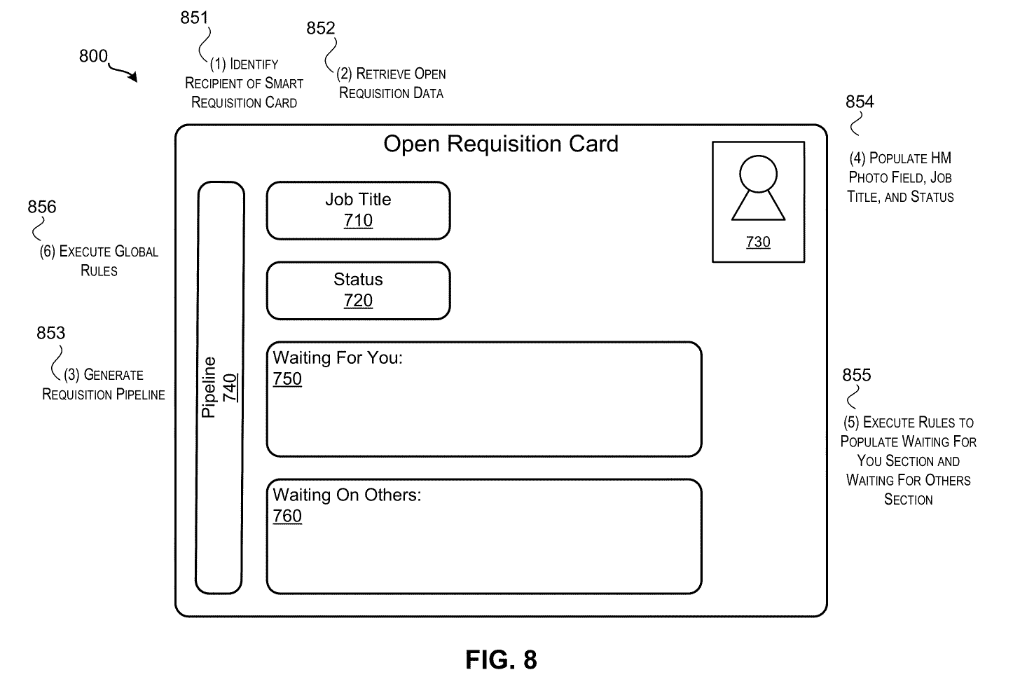

FIG. 8 illustrates a process for generating an open requisition card according to another embodiment. Process 800 can be stored in computer readable code and executed by a processor. For example, process 800 can be part of the computer readable code that is executed by recruiting tool 130 of FIG. 1. Process 800 can begin by identifying the recipient of the smart requisition card at step (1) (reference numeral 851). In one example, the recipient can be identified from the metadata within a smart requisition card request received by recruiting tool 130. The request can include metadata that identifies the member that submitted the request. Process 800 can continue by retrieving the open requisition data at step (2) (reference numeral 852). Open requisition data 200 is an example of what can be retrieved.

Once the open requisition data has been retrieved and the recipient of the open requisition card has been identified, process 800 can continue by generating requisition pipeline 740 at step (3) (reference numeral 853). The requisition pipeline can be generated from requisition pipeline data 220 that is a part of open requisition data 200. In one embodiment, requisition pipeline 740 can be positioned along the left hand border of the open requisition card. In one example, each stage of the hiring process can be presented as sector of requisition pipeline 740. In one embodiment, visual appearance of each sector can depend on the number of candidates that are currently within the stage. For example, each sector of requisition pipeline 740 can be presented as a different color, shade, or hue depending on the number of candidates that are currently within the stage.

Process 800 can continue by populating other generic fields of the open requisition card at step (4) (reference numeral 854). The other generic fields can include hiring manager photo field 730, job title field 710, and status field 720. Once the generic fields have been generated, process 800 can continue by executing rules for populating the personalized fields at step (5) (reference numeral 855). The personalized fields can include waiting for you field 750 (which is configured to present notifications for action items that have yet to be completed by the recipient of the open requisition card) and waiting on others field 760 (which is configured to present notifications for actions items that have yet to be completed by members within the organization other than the recipient of the open requisition card). The rules which are executed can be located within requisition cells of requisition card generation chart 500 of FIG. 5. Once the open requisition card has been generated, recruiting tool 130 can transmit the open requisition card to a client device associated with the recipient. The client device can present the open requisition card on a display of the client device for review by the recipient.

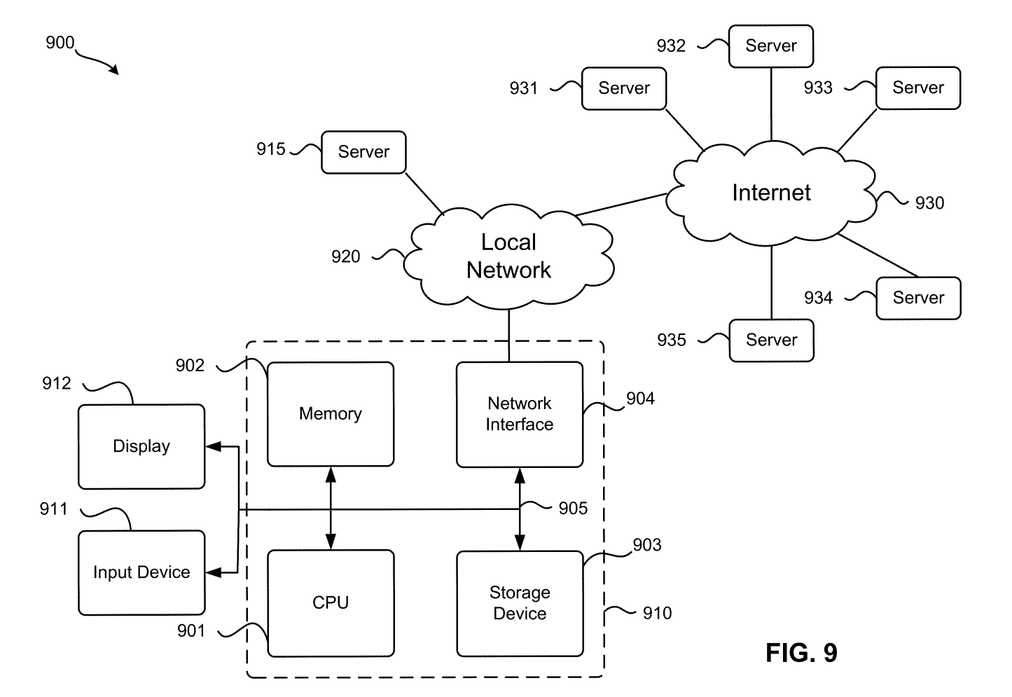

An exemplary computer system 900 is illustrated in FIG. 9. Computer system 910 includes a bus 905 or other communication mechanism for communicating information, and a processor 901 coupled with bus 905 for processing information. Computer system 910 also includes memory 902 coupled to bus 905 for storing information and instructions to be executed by processor 901, including information and instructions for performing the techniques described above, for example. This memory may also be used for storing variables or other intermediate information during execution of instructions to be executed by processor 901. Possible implementations of this memory may be, but are not limited to, random access memory (RAM), read only memory (ROM), or both. A storage device 903 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 903 may include source code, binary code, or software files for performing the techniques above, for example. Storage device and memory are both examples of computer readable mediums.

Computer system 910 may be coupled via bus 905 to a display 912, such as a cathode ray tube (CRT) or liquid crystal display (LCD), for displaying information to a computer user. An input device 911 such as a keyboard and/or mouse is coupled to bus 905 for communicating information and command selections from the user to processor 901. The combination of these components allows the user to communicate with the system. In some systems, bus 905 may be divided into multiple specialized buses.

Computer system 910 also includes a network interface 904 coupled with bus 905. Network interface 904 may provide two-way data communication between computer system 910 and the local network 920. The network interface 904 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 904 sends and receives electrical, electromagnetic, or optical signals that carry digital data streams representing various types of information.

Computer system 910 can send and receive information, including messages or other interface actions, through the network interface 904 across a local network 920, an Intranet, or the Internet 930. For a local network, computer system 910 may communicate with a plurality of other computer machines, such as server 915. Accordingly, computer system 910 and server computer systems represented by server 915 may form a cloud computing network, which may be programmed with processes described herein. In the Internet example, software components or services may reside on multiple different computer systems 910 or servers 931-935 across the network. The processes described above may be implemented on one or more servers, for example. A server 931 may transmit actions or messages from one component, through Internet 930, local network 920, and network interface 904 to a component on computer system 910. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method, comprising:
receiving, by a processor, a user request to check on the status of a plurality of open requisitions configured for filling a plurality of positions within an organization;
identifying, by the processor, an open requisition that a user profile associated with the user request is involved in, the open requisition being configured to fill an open position within the organization; and
generating, by the processor, an open requisition card that provides a summary on a plurality of candidates applying for the open requisition, wherein the open requisition card is personalized for the user profile.

2. The computer-implemented method of claim 1, wherein generating the open requisition card comprises:
generating, by the processor and as part of the open requisition card, a requisition pipeline configured to identify a current stage in a hiring process that each of the plurality of candidates are currently in.

3. The computer-implemented method of claim 1, wherein generating the open requisition card comprises:
determining, by the processor, a current stage that a candidate applying for the open position is in within a hiring process;
determining, by the processor, that the current stage contains an action item associated with the user profile; and
generating, by the processor and as part of the open requisition card, a to-do section that contains the action item.

4. The computer-implemented method of claim 3, further comprising:
detecting, by the processor, user input representative of selecting the action item; and
executing, by the processor, a function associated with the selected action, the function being configured to complete the selected action.

5. The computer-implemented method of claim 1, wherein generating the open requisition card comprises:
determining, by the processor, a current stage that a candidate applying for the open position is in within a hiring process;
determining, by the processor, that a subsequent stage contains an action item that is associated with the user profile, wherein the subsequent stage is dependent on the completion of the current stage; and
generating, by the processor and as part of the open requisition card, a waiting-for section that contains another action item which the completion of the current stage depends on.

6. The computer-implemented method of claim 5, further comprising:
detecting, by the processor, user input representative of selecting the another action item; and
presenting, by the processor and as part of the open requisition card, an option to generate a reminder to complete the another action item.

7. The computer-implemented method of claim 1, further comprising:
maintaining, by the processor, an open web socket with a client device which transmitted the user request, wherein the open web socket is configured to maintain an active connection between the client device and the processor to dynamically transmit updates to the open requisition from the processor to the client device.

8. A non-transitory computer readable storage medium storing one or more programs, the one or more programs comprising instructions for:
receiving a user request to check on the status of a plurality of open requisitions configured for filling a plurality of positions within an organization;
identifying an open requisition that a user profile associated with the user request is involved in, the open requisition being configured to fill an open position within the organization; and
generating an open requisition card that provides a summary on a plurality of candidates applying for the open requisition, wherein the open requisition card is personalized for the user profile.

9. The non-transitory computer readable storage medium of claim 8, wherein generating the open requisition card comprises:
generating, as part of the open requisition card, a requisition pipeline configured to identify a current stage in a hiring process that each of the plurality of candidates are currently in.

10. The non-transitory computer readable storage medium of claim 8, wherein generating the open requisition card comprises:
determining a current stage that a candidate applying for the open position is in within a hiring process;
determining that the current stage contains an action item associated with the user profile; and
generating, as part of the open requisition card, a to-do section that contains the action item.

11. The non-transitory computer readable storage medium of claim 10, further comprising:
detecting user input representative of selecting the action item; and
executing a function associated with the selected action, the function being configured to complete the selected action.

12. The non-transitory computer readable storage medium of claim 8, wherein generating the open requisition card comprises:
determining a current stage that a candidate applying for the open position is in within a hiring process;
determining that a subsequent stage contains an action item that is associated with the user profile, wherein the subsequent stage is dependent on the completion of the current stage; and
generating as part of the open requisition card, a waiting-for section that contains another action item which the completion of the current stage depends on.

13. The non-transitory computer readable storage medium of claim 12, further comprising:
detecting user input representative of selecting the another action item; and
presenting, as part of the open requisition card, an option to generate a reminder to complete the another action item.

14. The non-transitory computer readable storage medium of claim 8, further comprising:
maintaining an open web socket with a client device which transmitted the user request, wherein the open web socket is configured to maintain an active connection between the client device and the processor to dynamically transmit updates to the open requisition from the processor to the client device.

15. A computer implemented system, comprising:
one or more computer processors; and
a non-transitory computer-readable storage medium comprising instructions, that when executed, control the one or more computer processors to be configured for:
receiving a user request to check on the status of a plurality of open requisitions configured for filling a plurality of positions within an organization;
identifying an open requisition that a user profile associated with the user request is involved in, the open requisition being configured to fill an open position within the organization; and
generating an open requisition card that provides a summary on a plurality of candidates applying for the open requisition, wherein the open requisition card is personalized for the user profile.

16. The computer implemented system of claim 15, generating, as part of the open requisition card, a requisition pipeline configured to identify a current stage in a hiring process that each of the plurality of candidates are currently in.

17. The computer implemented system of claim 15, wherein generating the open requisition card comprises:
determining a current stage that a candidate applying for the open position is in within a hiring process;
determining that the current stage contains an action item associated with the user profile; and
generating, as part of the open requisition card, a to-do section that contains the action item.

18. The computer implemented system of claim 17, further comprising:
detecting user input representative of selecting the action item; and
executing a function associated with the selected action, the function being configured to complete the selected action.

19. The computer implemented system of claim 18, wherein generating the open requisition card comprises:
determining a current stage that a candidate applying for the open position is in within a hiring process;
determining that a subsequent stage contains an action item that is associated with the user profile, wherein the subsequent stage is dependent on the completion of the current stage; and
generating as part of the open requisition card, a waiting-for section that contains another action item which the completion of the current stage depends on.

20. The computer implemented system of claim 19, further comprising:
detecting user input representative of selecting the another action item; and
presenting, as part of the open requisition card, an option to generate a reminder to complete the another action item.
